(19) United States
(12) Patent Application Publication
(10) Pub. No.: US 2010/0169195 A1
(43) Pub. Date: Jul. 1, 2010

(54) Preventing unauthorized distribution of content on computer networks

(76) Inventor: Bernard Trest, Toronto (CA)

Correspondence Address: Bernard Trest, 76 Castlebury Cres Unit 3, Toronto, ON, M2H1W8, CA

(21) Appl. No.: 11/814,804

(22) PCT Filed: Feb. 3, 2006
(86) PCT No.: PCT/CA2006/000138

§ 371 Date: Apr. 14, 2008

Related U.S. Application Data
(60) Provisional application No. 60/649,657, filed on Feb. 3, 2005.

(51) Int. Cl. G06F 17/30; G06Q 10/00; G06Q 50/00; G06Q 30/00

(52) U.S. Cl. 705/34; 707/781; 707/769; 705/318; 707/E17.005; 707/E17.014

(57) ABSTRACT

A method of interfering with unauthorized distribution of protected content via a computer network comprises receiving a query for content from a requesting device connected to the network; determining whether the query relates to the protected content; and in the event that the query relates to the protected content, automatically taking an interfering action in respect of the requesting device. An apparatus, computer program and system of network sentries is also provided.

### FIELD OF THE INVENTION

The system and methods disclosed herein relate generally to distribution of content on a computer network, and more particularly to a method, apparatus and system for interfering with the unauthorized distribution of protected content via the computer network.

### BACKGROUND OF THE INVENTION

The proliferation of the Internet, and in particular of Peer-to-Peer (P2P) networks has resulted in widespread unauthorized distribution of content covered by copyright and other intellectual property laws. Large numbers of users are said to engage in the unauthorized distribution of copyrighted material such as songs, images, movies, computer software, games, and other intellectual property using standard client device software such as Morpheus, Limewire, Bearshare, eMule, or Kazaa via P2P networks such as Gnutella, Gnutella2, eMule, FastTrack, BitTorrent, NeoNet, and others. Efforts by owners of copyrighted content to stop the unauthorized distribution of their content across P2P networks have, thus far, met with little success.

Some content owners have tried distributing corrupt “garbage” files across P2P networks to interfere with those who attempt to download their content without authorization. The content owners generate files filled with “garbage” data, and accord the files names that correspond to the content the content owners wish to protect. They then let standard P2P client software such as LimeWire distribute the garbage files as though it were valid content.

The manual creation of garbage files and use of standard P2P client software has met with limited success. For example, standard P2P clients are generally only permitted to connect to a relatively small part of the P2P network, generally in order to minimize message traffic on the network. Because of this design consideration, however, distribution of garbage files and therefore interference with unauthorized distribution of protected content is inherently limited to the small part of the network to which the standard P2P client is connected. Furthermore, this method is inherently limited to actual files pre-produced and provided with false file names. Preparation of the garbage files and their naming prior to distribution can be extremely time consuming, and can take up a great deal of storage space.

Other limitations of the above-described method include the fact that many P2P clients allow their uses to rate files by associating comments with the files' respective unique hash (such as an MD5 or SHA-1 hash), enabling the quick identification of garbage files being distributed via a standard P2P client as imposters and avoided for download. Determination of which garbage files have been identified as imposters and provision of replacement garbage files for fulfilling the purpose of the identified imposter can be a complex and time-consuming task.

### SUMMARY OF THE INVENTION

According to one aspect there is provided a method of interfering with unauthorized distribution of protected content via a computer network, the method comprising:

receiving a query for content from a requesting device connected to the network;

determining whether the query relates to the protected content;

in the event that the query relates to the protected content, automatically taking an interfering action in respect of the requesting device.

According to another aspect there is provided an apparatus for interfering with unauthorized distribution of protected content via a computer network, the apparatus comprising:

a communications interface for receiving a query for content from a requesting device connected to the network;

a processor for determining whether the query relates to the protected content;

the processor further for, in the event that the query relates to the protected content, automatically taking an interfering action in respect of the requesting device.

According to another aspect, there is provided a system for interfering with unauthorized distribution of protected content via a computer network, the system comprising:

a plurality of network sentries, each of the network sentries comprising:

a communications interface for receiving a query for content from a requesting device connected to the network;

a processor for determining whether the query relates to the protected content; and

the processor further for, in the event that the query relates to the protected content, automatically taking an interfering action in respect of the requesting device;

the system further comprising:

a central server in communication with the network sentries for sharing communications addresses of devices connected to the network with the network sentries.

According to another aspect there is provided a computer readable medium including a computer program for interfering with unauthorized distribution of protected content via a computer network, the computer program comprising:

computer program code for receiving a query for content from a requesting device connected to the network;

computer program code for determining whether the query relates to the protected content; and

computer program code for in the event that the query relates to the protected content, automatically taking an interfering action in respect of the requesting device.

### BRIEF DESCRIPTION OF THE DRAWINGS

Embodiments will now be described more fully with reference to the accompanying drawings, in which:

FIG. 1 is a block diagram of a system for interfering with unauthorized distribution of protected content on a peer-to-peer network, according to an embodiment of the invention;

FIG. 2 is a block diagram better illustrating a network sentry of the system shown in FIG. 1; and

FIG. 3 is an exemplary display on the screen of a requesting device containing false search results.

### DETAILED DESCRIPTION OF THE EMBODIMENTS

The following includes description of the invention operating in the context of a Gnutella peer-to-peer (P2P) networking environment. However, one of ordinary skill in the art will be able to apply the described principles in other networking environments, where applicable, such as other peer-to-peer networks, hybrid networks utilizing peer-to-peer concepts in combination with client-server concepts, and client-server networks.

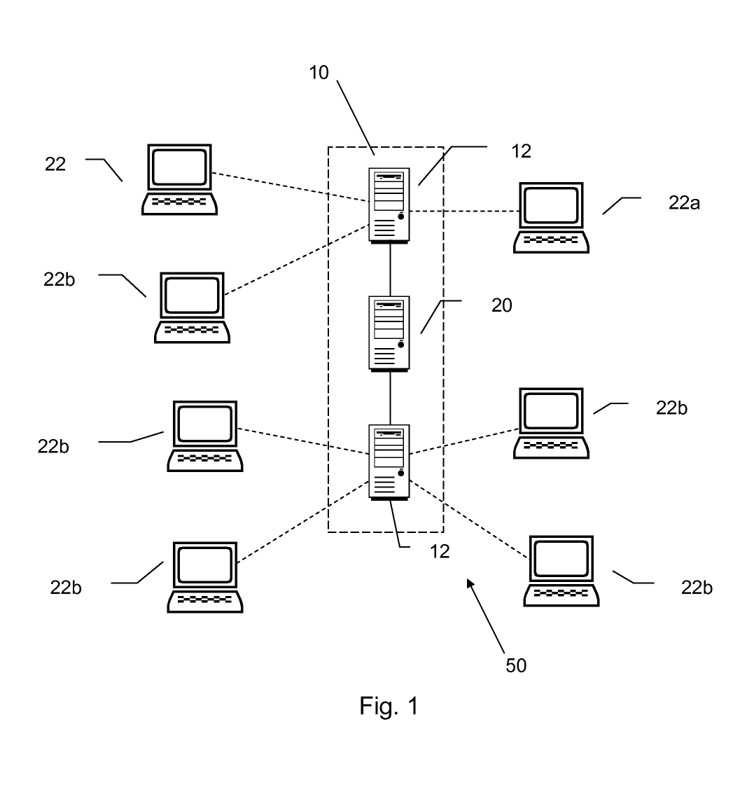

FIG. 1 is a block diagram of a Gnutella peer-to-peer computer network 50 including Gnutella client devices 22 and a system 10 for interfering with unauthorized distribution of protected content on the network, according to one embodiment of the invention. System 10 comprises a plurality of network sentries 12, each having a unique network communications address (“Internet Protocol” or “IP” address), that in communication with a central server 20 for co-ordinating their actions.

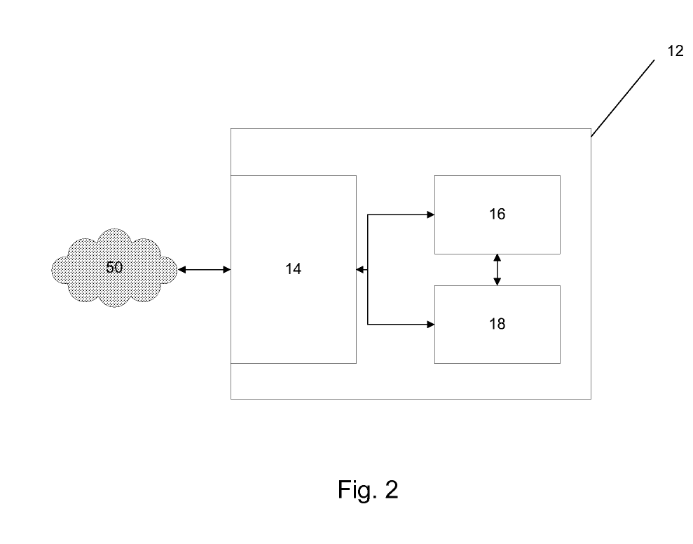

FIG. 2 is a block diagram better illustrating a single network sentry 12. Network sentry 12 may transmit to and receive messages from devices on network 50 via a communications interface 14. A processor 16 receives messages from communications interface 14 and, in conjunction with electronic storage 18 (RAM, hard disk etc.), controls operation of network sentry 12, as will be described.

Network sentry 12 may be embodied in a software application including computer executable instructions executed by a processing unit such as a personal computer having a communications interface 14 for transmitting and receiving network data, and storage 18, or other computing system environment. The software application may run as a stand-alone tool on a personal computer or server, or may be incorporated into other available routers or other networking hardware to provide enhanced functionality to the networking hardware. The software application may include program modules including routines, programs, object components, data structures etc. and be embodied as computer readable program code stored on a computer readable medium. The computer readable medium is any data storage device that can store data, which can thereafter be read by a computer system. Examples of computer readable medium include for example read-only memory, random-access memory, CD-ROMs, magnetic tape and optical data storage devices. The computer readable program code can also be distributed over a network including coupled computer systems so that the computer readable program code is stored and executed in a distributed fashion.

Each network sentry 12 is also capable of connecting to a plurality of Gnutella client devices 22 operating under the control of known P2P client software, as will be described. Each network sentry 12 masquerades as one of the Gnutella client devices 22 by being available to the Gnutella client devices 22 for making connections, receiving search queries, providing search results and transferring files using the Gnutella protocol.

Provision of a plurality of network sentries 12, each capable of connecting to a plurality of Gnutella client devices 22 as described, enables broad coverage of the network 50 and a high amount of network bandwidth available to system 10 for interfering with unauthorized distribution of protected content. Furthermore, in the event that a network sentry 12 is somehow blacklisted and thereby blocked from access to the computer network 50, the remaining network sentries 12 remain able to continue interfering with the unauthorized distribution of protected content.

For the purpose of clarity, the following description will refer to requesting Gnutella client device 22a and responding Gnutella client devices 22b as different entities in order to track the flow of data. The distinction between the two is that the requesting Gnutella client device 22a described herein makes the initial request for content during the method to be described. It will be understood, however, that each of device 22a and devices 22b is under the operation of standard P2P client software and operates, for the purposes described, in like manner.

It will be understood that “content” and “file(s)” when used in this description refer to electronic, computer-readable files embodying songs (in MP3, Windows Media or some other format), movies (in MPEG, AVI, QuickTime, DivX, Windows Media or some other format), software programs, games, images (in JPEG or some other format), or other similar items. “Protected content” and “protected file(s)” refers to any content that the owner of that content wishes to prevent from distribution over P2P networks. An owner of protected content may be, for example, a movie studio that wishes to stop its movies from being freely distributed, or a record company that wishes to stop its songs from being freely distributed.

It will also be understood that, while the invention described herein may indeed in many circumstances prevent unauthorized distribution of some or all protected content on a network 50 in which it operates, due to the nature of computer networks, P2P networks in particular, and the difficulty of predicting a user's behavior, the invention in many cases may significantly interfere but not prevent unauthorized distribution of protected content. In this regard, the invention is able to interfere in some manner where it is aware of a query from a requesting device 22b for protected content. As such, the system's efficacy for interference increases as each network sentry 12 connects with a higher percentage of the other devices 22 on the network 50 with which it is associated, because it becomes aware of a greater percentage of the queries. The interference referred to herein has as its goal to cause a user certain frustration or delay when attempting to access protected content by interspersing valid search results with false ones which can lead to false files or false file paths, and/or to direct the user to a legitimate source where protected content may be purchased, or other similar interfering actions.

The following description is provided in order to better illustrate the operation of the invention, and is generally made with reference to a single network sentry 12. It will be understood that the other network sentries 12 in system 10 will operate in a like manner.

To connect to the devices 22 on the Gnutella network 50, network sentry 12 requires the IP addresses and ports of the devices 22. Although Gnutella client devices 22 typically use port 6346 to accept incoming connections, any available port may be employed. The Gnutella protocol takes this factor into account by distributing port numbers along with IP addresses whenever an IP address is required. Initially, the IP addresses and ports are obtained by network sentry 12 from one or more central web servers called Gnutella web caches that are available to all network devices. Gnutella web caches use the HyperText Transfer Protocol (HTTP) to receive the addresses of Gnutella client devices 22 from other Gnutella client devices 22, and offer these IP addresses and ports to new devices requesting connection with the Gnutella network 50.

Network sentry 12 masquerading as a Gnutella client device 22 by communicating in a similar manner using the Gnutella protocol may obtain an initial list of IP address and ports of other Gnutella client devices 22 from several Gnutella web caches. However, because each web cache typically returns only a small number of IP addresses and ports upon request, and further because web caches usually incorporate some mechanism to discourage repeated requests to the web caches, this results in a somewhat limited supply of IP addresses and ports.

Network sentry 12 therefore also collects IP addresses and ports of Gnutella client devices 22 during the process of connecting with Gnutella client devices 22. Additionally, IP addresses and ports are obtained from PONG messages, which Gnutella client devices 22 return in response to PING broadcast messages, as will be described.

Periodically, network sentry 12 uploads its list of obtained addresses (IP addresses and ports) of Gnutella client devices 22 to central server 20 using the HyperText Transfer Protocol (HTTP). A typical list of obtained addresses appears as follows:

218.12.3.2:6346

201.4.12.31:6346

204.124.231.12:7842

Each line above represents the IP address and port of a single Gnutella client device 22, as follows: <IP ADDRESS>:<PORT>. These items are added to a central list on central server 20 that is stored in a database such as Microsoft™ SQLServer. The central list is also accessible by other network sentries 12 via HTTP.

Network sentry 12 connects to many Gnutella client devices 22 at once in order to monitor messages being passed and be able to effectively interfere with the unauthorized distribution of protected content. The following description provides the method used by network sentry 12 for connecting with a single Gnutella client device 22.

To begin the connection process, network sentry 12 uses the IP address and port of a single Gnutella client device 22 to establish a TCP/IP connection with the Gnutella client device 22, as will be understood by one of ordinary skill in the art. Once a TCP/IP connection is established, network sentry 12 begins a handshaking procedure by sending the following first handshaking message to the Gnutella client device 22 with which it has established a TCP/IP connection:

GNUTELLA CONNECT/0.6

X-Max-TTL: 7

X-Dynamic-Querying: 0.1

X-Version: 3.8.4

X-Query-Routing: 0.1

User-Agent: LimeWire/3.1.1

Vendor-Message: 0.1

X-Ultrapeer-Query-Routing: 0.1

GGEP: 0.5

Listen-IP: 69.197.158.149:6100

Pong-Caching: 0.1

X-Guess: 0.1

X-Ultrapeer: True

X-Degree: 32

X-Locale-Pref: en

Accept-Encoding: deflate

Remote-IP: 141.155.148.49

Each line in the first handshaking message is terminated with a carriage return (ASCII character 13)/linefeed (ASCII character 10) pair. The “X-Ultrapeer: True” line indicates that the handshaking network sentry 12 is functioning as an ultrapeer. In a typical Gnutella network 50, Gnutella client devices 22 are divided into leaf nodes and ultrapeers. The leaf nodes are typically less powerful computers on low-bandwidth connections such as a dial-up line, while ultrapeers are more powerful computers on high-speed lines such as DSL or cable modem. Ultrapeers are responsible for maintaining lists of content shared by themselves and other Gnutella client devices 22, as well as processing search requests, while leaf nodes have little or no participation in processing searching requests due to the limited network bandwidth and computing power at their disposal. Gnutella client devices 22 usually automatically assign themselves a role as either a leaf node or an ultrapeer depending on the processing power and memory of the computer on which they're running, the network connection type and bandwidth available, and other factors. According to the present embodiment, network sentry 12 identifies itself to the handshaking Gnutella client device 22 as an ultrapeer, indicating that it is available to receive and process search requests.

In response to the first handshaking message, Gnutella client device 22 provides the following second handshaking message:
GNUTELLA/0.6 200 OK
X-Version: 4.0.4
Pong-Caching: 0.1
X-Ultrapeer-Needed: true
Accept-Encoding: deflate
Content-Encoding: deflate
X-Guess: 0.1
X-Max-TTL: 3
Vendor-Message: 0.1
X-Ultrapeer-Query-Routing: 0.1
X-Query-Routing: 0.1
Listen-IP: 68.63.168.177:6346
X-Ext-Probes: 0.1
Remote-IP: 69.197.158.149
GGEP: 0.5
X-Dynamic-Querying: 0.1
X-Degree: 32
User-Agent: LimeWire/3.6.15
X-Ultrapeer: True
X-Try-Ultrapeers: 220.57.100.171:6346, 82.39.2.28:6346, 172.175.208.135:6348, 24.14.57.208:6346

The “X-Try-Ultrapeers” line (or “X-Try” line, where applicable), is used by the Gnutella protocol to denote the IP addresses and ports of other Gnutella client devices 22 with which handshaking Gnutella client device 22 has recently communicated. During the handshaking, the “X-Try-Ultrapeers” IP addresses and ports are stored by network sentry 12 for using to make connections and for other uses, such as for upload to central server 20 to make the IP addresses and ports available to other network sentries 12.

Network sentry 12 then completes the handshaking by providing the following third handshaking message in to the handshaking Gnutella client device 22:

GNUTELLA/0.6 200 OK

Content-Encoding: deflate

The “Accept-Encoding: deflate” and “Content-Encoding: deflate” lines in the above handshaking exchange indicate to a Gnutella client device 22 that network sentry 12 supports message compression. Message compression is preferred in order to reduce the network bandwidth required by network sentry 12.

Once the handshaking process is completed a connection is established in which further communications occur as binary data. For ease of description, the following refers to the uncompressed format of the binary data, which may alternatively be compressed prior to transfer and uncompressed after transfer to reduce use of network bandwidth.

Gnutella client device 22 generally communicates by sending messages, each beginning with a 23-byte header. The header is structured as follows:

TABLE 1
Gnutella Message Header.

| Bytes | Description |
|---|---|
| 0-15 | Message ID/GUID (Globally Unique ID) |
| 16 | Payload Type |
| 17 | TTL (Time To Live) - the number of hops to be taken before |
| | discarding the message |
| 18 | Hops - the number of hops already taken by this message |
| 19-22 | Payload Length |

Byte 16 in Table 1 contains a value that describes the message following the header. Several different message types can be sent. Most important to the operation of the invention are the PING, PONG, QUERY and QUERY HIT messages, as will be described

The PING message is identified in payload type byte 16 of the header by a byte value of 0 (hexadecimal). A PING message is a request by a network device that other network devices identify themselves. Periodically, network sentry 12 sends PING messages to obtain information about Gnutella client devices 22 on the network 50.

A PONG message is identified in payload type byte 16 of the header by a byte value of 1 (hexadecimal). A PONG message is a sent by network devices in response to a PING message. A PONG message has the following structure:

TABLE 2
Gnutella PONG Message.

| Bytes | Description |
|---|---|
| 0-1 | Port number. The port number on which the responding host can |
| | accept incoming connections. |
| 2-5 | IP Address. The IP address of the responding host. |
| 6-9 | Number of shared files. |
| 10-13 | Number of kilobytes shared. |
| 14- | OPTIONAL GGEP extension block |

When network sentry 12 receives a PONG message, it can extract the IP address and port of the Gnutella client device 16 that sent the PONG message. This information may be used by network sentry 12 and/or uploaded to central server 20 for use by other network sentries 12.

A QUERY message is identified in payload type byte 16 of the header by a byte value of 80 (hexadecimal). A QUERY message is sent by a requesting Gnutella client device 22a when its user is searching for content to download, and is received by network sentry 12 to which requesting Gnutella client device 22a is connected. A QUERY message has the following structure:

TABLE 3
Gnutella QUERY Message.

| Bytes | Description |
|---|---|
| 0-1 | Minimum Speed. |
| 2- | Search Criteria. This field is terminated by a NUL (0x00). |
| Rest | OPTIONAL extensions block. |

Bytes 0-1 represent the minimum download speed that requesting Gnutella client device 22a making the query is willing to accept. In order to provide effective interference with transfer of protected content where required, network sentry 12 disregards the Minimum Speed threshold of requesting Gnutella client device 22a.

The “Search Criteria” in bytes 2- are usually one or more words such as “Britney Spears”; “Hit Me Baby One More Time”; “Star Wars Sith”; or “Adobe Photoshop”.

A QUERY HIT message is identified in payload type byte 16 of the header by a byte value of 81 (hexadecimal). A QUERY HIT message is intended to be sent by a responding Gnutella client device 22b to requesting Gnutella client device 22a, informing requesting Gnutella client device 22a that responding Gnutella client device 22b has the desired content. As will be described, network sentry 12 also sends QUERY HIT messages in response to QUERY messages that relate to protected content. The QUERY HIT message has the following structure:

TABLE 3
Gnutella QUERY HIT Message.

| Bytes | Description |
|---|---|
| 0 | Number of Hits. The number of query hits in the result set |
| 1-2 | The port number on which the responding host can accept |
| | incoming HTTP file requests |
| 3-6 | IP Address. The IP address of the responding host. |
| 7-10 | The speed (in kb/second) of the responding host |
| 11- | Result Set. A set of responses to the corresponding Query |
| X | RECOMMENDED extra block. |
| X | Private Data. Undocumented vendor-specific data. |
| Last 16 | Identifier. A 16-byte string uniquely identifying the client. |

The Result Set in bytes 11- contains a number of entries equal to the Number of Hits in Byte 0 of the QUERY HIT message. Each entry has the following structure:

TABLE 4
Gnutella QUERY HIT Message Result Set Entry.

| Bytes | Description |
|---|---|
| 0-3 | File Index. A number, assigned by the responding host, used to |
| | uniquely identify the file |
| 4-7 | File Size. The size (in bytes) of the file |
| 8- | File Name. The name of the file |
| X | Extensions block - SHA-1 hash of the file and other information |
| | can be stored here |

Network sentry 12 stores a list of protected content in a text file as a set of entries separated by carriage return/line feed combination. Each entry in the list is a <PHRASE>,<FEE> combination, an example of which is shown as follows:

Britney Spears, 0.20

Elton John, 0.20

Electric Light Orchestra, 0.10

Star Wars Sith, 0.85

Wedding Crashers, 0.85

Microsoft Office, 1.50

MS Office, 1.50

Splinter Cell, 1.00

The <PHRASE> portion of the entry is compared with a Search Criteria received in a QUERY message from requesting Gnutella client device 22a to which a network sentry 12 is connected. Wildcards, regular expressions and/or other pattern matching techniques may be employed in any known manner. Alternatively, the <PHRASE> portion may be a unique hash code generated according to MD5 (a 128 bit fingerprint uniquely identifying a file), and/or by some other means.

The role of the <FEE> portion of the entry is for charging a fee to the content owner upon interference with a transfer of content matching the corresponding <PHRASE>.

If a <PHRASE> in an entry is found that matches the words in the Search Criteria, then the QUERY message is flagged by the network sentry 12 as being for protected content. Preferably, the matching scheme provides flexibility for content providers. For example, a matching scheme that takes alternate spellings and filename variations into account, and allows, for example, a record label the option of protecting the content of a particular artist simply by listing that artist instead of having to compile and list a full catalog of all the songs recorded by the artist. With such a flexible matching scheme, network sentry 12 flags a QUERY message containing Search Criteria “Britney Spears” as being for protected content upon matching with the list of protected content. In a similar manner, a QUERY message containing Search Criteria “Britney Spears—Baby One More Time” is also flagged as being for protected content. QUERY messages containing any one of “Splinter Cell”, “Splinter Cell: Pandora Tomorrow”, “Wedding Crashers”, “Star Wars III Revenge of the Sith” and “Microsoft Office (Full Version)” is also flagged. Preferably, the matching scheme enables protection of specific content, such as only particular songs by an artist and not others.

When a match between the Search Criteria and the <PHRASE> is identified, it is determined that Gnutella client device 22a is searching for protected content which has not be authorized for transfer on the network 50. In this event, network sentry 12 identifying the match automatically performs one or more actions to interfere with a transfer of the protected content across the Gnutella network 50.

One such interfering action is the transmission of at least one false search result in the form of one or more false QUERY HIT messages. In order to create the false QUERY HIT messages, network sentry 12 begins gathering information about a valid match from the other Gnutella client devices 22b on the network 50. In order to gather information, network sentry 12 relays the received QUERY message (with modified header to make network sentry 12 appear as the original QUERY) to secondary ones of Gnutella client devices 22b to which it is connected. Each secondary Gnutella client device 22b that identifies a file match returns to network sentry 12 secondary QUERY HIT messages which, in their Result Set Entry (see Table 4) contain filename and file size information about the file match. For each secondary QUERY HIT message received, network sentry 12 extracts the filename and file size.

For each QUERY HIT message network sentry 12 receives from secondary Gnutella client devices 22b, one or more file definitions are created and stored by network sentry 12 for future use. For the purposes of the invention, the file definitions do not have to correspond to actual files, but are used to appear as such when contained in false QUERY HIT messages. Each of the file definitions has the same or slightly (perhaps randomly) modified filenames as those received in secondary QUERY HIT messages from secondary Gnutella client device 22b, a slightly different file size, and a randomly generated SHA-1 (Secure Hash Algorithm-1) hash.

Each file definition has a randomly generated hash and slightly different file size as described above in order to spoof the display scheme of requesting Gnutella client device 22a into making it appear as though there are different files available for download. Many Gnutella client devices 22 use the hash to uniquely identify files, and the user is able to generate comments and associate them with a file using its hash. Should a file definition in a false QUERY HIT transmitted by network sentry 12 be tagged by requesting Gnutella client device 22a as “bad”, or the randomly generated hash associated with negative user comments, network sentry 12 is not prevented from interfering with unauthorized transfer of protected content. This is because network sentry 12 will in most cases transmit a file definition with a hash that requesting Gnutella client device 22a has not yet received. Requesting Gnutella client device 16a therefore treats the file as new. The random generation of the hash, as opposed to predictable step changes in hashes, reduces the chance that a sophisticated requesting Gnutella device 22a is able to track patterns in the hashes coupled with “bad” file definitions.

Once network sentry 12 has generated a set of file definitions, then, for each file definition, network sentry 12 generates a number of QUERY HIT messages for transmission to requesting Gnutella client device 22a.

The QUERY HIT messages are composed in order to be displayed prominently to a user of requesting Gnutella client device 22a. Preferably, the false QUERY HIT messages transmitted by network sentry 12 are designed to fill the search results display of requesting Gnutella client device 16a with false search results. For example, many Gnutella client devices 22 display search results sorted by the number of other Gnutella client devices 22 (which network sentry 12 appears to be) hosting that file, with files hosted by several Gnutella client devices 22 appearing near the top of the display and files hosted on a single Gnutella client device 22 appearing at the bottom. Network sentry 12 transmits a set of false QUERY HIT messages containing a single file definition, with at least one false QUERY HIT identifying network sentry 12 (with IP address and port) as having that “file”, and zero or more false QUERY HITS containing the same file definition but randomly generated IP addresses and ports (dead ends).

In a typical example, network sentry 12 responds by transmitting one (1) false QUERY HIT message falsely identifying network sentry 12 as having a copy of the file, along with five (5) false QUERY HIT messages containing the same file definition (same filename, file size, hash), and randomly-generated IP addresses and ports. When requesting Gnutella client device 22a receives the six (6) QUERY HITS, it displays the QUERY HITS so as to appear to the user that a file is hosted by six (6) different Gnutella client devices 22b. In order to increase the chances of selection by a user of the one (1) false QUERY HIT identifying network sentry 12 as having a copy of the file for providing further interference (as will be described), the one (1) false QUERY HIT message includes a high download bandwidth speed.

By varying the number of false QUERY HITS transmitted to requesting Gnutella client device 22a for each file definition, network sentry 12 is able to scatter large numbers of false search results throughout the search results display of requesting Gnutella client device 22a.

The above-described process interferes with the unauthorized transfer of protected content via the network 50, because selection by a user of a false search result in their search results display leading to a dead end as described above is likely to result in some frustration and confusion due to the difficulty for a user of filtering false search results obtained from a network sentry 12 from valid ones obtained from Gnutella client devices 22b. However, it is markedly more frustrating and time-consuming for a user to download large volumes of false content with the hopes of receiving desired content. As such, network sentry 12 preferably further interferes with the unauthorized distribution of protected content by offering false content for download.

For each file definition created by network sentry 12, there is a false QUERY HIT identifying network sentry 12 as having a copy of the corresponding file. When the user of requesting Gnutella client device 22a selects one or more of the “files” on network sentry 12 for download, requesting Gnutella client device 22a sends download requests to those in the search results display purporting to have the files. The dead ends will not result in a usable response, but network sentry 12 will respond to the download request by sending a false file of unusable data, or “garbage”.

According to the Gnutella protocol, network devices transfer files by employing a version of the HyperText Transfer (HTTP) protocol. Accordingly, requesting Gnutella client device 22a initiates a download by sending a request to network sentry 12 as follows:
GET /uri-res/N2R ?urn:sha1:PLSTHIPQGSSZTS5FJUPAKUZWUGYQYPFB HTTP/1.0
User-Agent: Gnutella
Host: 123.123.123.123:6346
Connection: Keep-Alive
Range: bytes=0-

In response, network sentry 12 transmits the following:

HTTP/1.1 200 OK

Server: Gnutella

Content-type: application/binary

Content-length: 4356789

Network sentry 12 then begins the time-consuming process of transferring randomly generated garbage data to requesting Gnutella client device 22a. This process may be made even more time-consuming by a limitation by network sentry 12 of the transfer speed, despite having indicated in its QUERY HIT message that it offers a higher speed of transfer. When requesting Gnutella client device 22a has finished downloading, the user will then find that an unusable “garbage” file has been received.

Requesting Gnutella client device 22a may implement a mechanism, such as the SHA-1 hashing algorithm, to verify the integrity of downloaded files. One weakness of the SHA-1 algorithm that can be exploited by network sentry 12 is that it can only be used on a file that has fully downloaded. Therefore, only once a user has downloaded “garbage” data from network sentry 12 can the SHA-1 algorithm be applied to the downloaded data to determine that it is garbage. While it may be then flagged as corrupt, the user's time and network bandwidth has already been wasted, and the process of unauthorized distribution of protected content interfered with.

Requesting Gnutella client device 22a may require use of a more sophisticated algorithm called TigerTree to split a file into small chunks (for example, 1 Mb) and generates a hash for each of the chunks. Requesting Gnutella client device 22a may then check the integrity of each chunk of data as it is downloaded, thereby allowing requesting Gnutella client device 22a to know, prior to transfer of the entire large file, whether it is wasting time downloading corrupt data. Usually, however, requesting Gnutella client device 22a will be willing to transfer files whether or not the host of the files supports the TigerTree algorithm. Network sentry 12 exploits the fact by simply not providing TigerTree hashes and operating as has been described.

Network sentry 12 may be configured to support TigerTree hashes, and may continue to effectively interfere as has been described because it continues to send garbage data in response to several re-requests for a “bad” chunk from requesting Gnutella client device 22a. Alternatively, network sentry 12 may cut off the transfer after a small amount of data has been transferred, before requesting Gnutella client device 22a has received enough data to compute the first chunk of the TigerTree hash. The transfer of some data will have caused the user of requesting Gnutella client device 22a some inconvenience and, in the event that requesting Gnutella client device 22a re-requests an aborted download, the process of transferring garbage data can continue, further inconveniencing the user.

In order to more effectively work around a TigerTree hash requirement, network sentry 12 first generates a garbage set of data and computes the TigerTree hash for the entire data set. For each download request network sentry 12 randomly scrambles one or more chunks of the TigerTree hash and the file that are to be transferred later. When requesting Gnutella client device 22a begins downloading the chunks and checking them against their TigerTree hash as the download continues, nothing appears at first to be amiss. Requesting Gnutella client device 22a, however, will have downloaded large amounts of data before encountering the later randomly scrambled parts, thereby wasting the user's time and network bandwidth downloading large amounts of “garbage” data.

An additional alternative for working around a TigerTree hash is for network sentry 12 to, for each QUERY with matching Search Criteria and/or corresponding download, generate an entire file filled with random data, along with valid SHA-1 and TigerTree hashes for that data. Requesting Gnutella client device 22a will have downloaded the entire file without knowing from the hashes that it contains “garbage” data. The user's time and network bandwidth will therefore already have been wasted.

It may be impractical to randomly generate files and compute hash sets for all matching QUERY messages due to the large amounts of processing power and storage space required for such an endeavor. A more practical alternative is to pre-generate a set of random garbage files, with their respective SHA-1 and TigerTree hashes and, on a random basis, transmit these hashes in QUERY HIT messages to requesting Gnutella client device 22a. In this case, it is advantageous to periodically and automatically pre-generate new sets of garbage files and hashsets so that those hashes that happen to be tagged by Gnutella client device 22a as “bad” do not prevent network sentry 12 from continuing to interfere with the unauthorized transfer of protected content.

In order to track the efficacy of the system 10, network sentry 12 stores information about downloads in a log file in storage 18. The log file is preferably a database file but may be text file or any other type of file suitable for storing log information. The contents of the log file may be used to prepare a report that is periodically sent to content owners to inform them of the actions taken to protect their content by interfering with its unauthorized distribution, for billing purposes, and to provide further information about the activities of network users should the content owner with to take further action, such as filing a lawsuit or pursuing criminal charge or contacting the P2P user's Internet Service Provider (ISP).

A useful log file would appear as follows:

TABLE 5
Log File

| Filename | Size | IP Address | Date | Time | Fee |
|---|---|---|---|---|---|
| Britney Spears - One More | 4,203,102 | 205.12.8.2 | Jan. 8, 2006 | 9:24 am | 0.20 |
| Time.mp3 | | | | | |
| Britney Spears - | 4,121,982 | 243.18.0.1 | Jan. 8, 2006 | 9:25 am | 0.20 |
| Sometimes.mp3 | | | | | |
| MS Office.iso | 492,391,293 | 214.3.19.4 | Jan. 8, 2006 | 9:27 am | 1.50 |
| Wedding Crashers.mpg | 892,192,452 | 219.0.12.3 | Jan. 8, 2006 | 9:28 am | 0.85 |
| | | | | TOTAL | 2.75 |

The IP addresses in the log file of Table 5 are the IP addresses of the various requesting Gnutella client devices 22a attempting to receive protected content without authorization, and with which network sentry 12 has interfered by transferring false files instead.

The Fees in Table 5 may be charged on a per-download basis, so that content owners are only actually charged for each unauthorized download network sentry 12 interfered with by sending a false file instead. A fee is obtained from the list of protected content described above.

Transmission of false search results may also be logged in a similar manner as has been described for transfer of false files, since transmission of false search results is an interfering action that a content owner may wish to track.

It can be seen that network sentry 12 operates differently than do Gnutella client devices 22 under the control of standard P2P client software, and can therefore be markedly more effective for interfering with unauthorized distribution of protected content. For example, because standard P2P client software is limited to connecting to a relatively small part of the P2P network 50 in order to minimize message traffic on the P2P network 50, corrupt files distributed by merely spoofing a standard P2P client with false filenames according to the prior art have limited distribution. This limitation is addressed by the network sentry 12 obtaining communications addresses for connecting to larger numbers of Gnutella client devices 22 at once, thereby maximizing its receipt of QUERY messages and its distribution of false QUERY HIT messages and false files across the network 50.

A further reason that network sentry 12 operating as described is more effective than use of a standard Gnutella client device 22, is that network sentry 12 does not require a fixed set of files in order to interfere. The standard Gnutella client device 22 limits the set of content that can be protected because it is designed to require an actual file to list as available. In contrast, network sentry 12 does not use a fixed set of files, but rather dynamically monitors QUERY and QUERY HIT messages passing along the Gnutella network 50, and generates its own false file definitions and QUERY HIT messages based on the monitoring as has been described. As a result, interference is far more flexible and far-reaching.

Yet another reason network sentry 12 operating as described is more effective is that it is capable of manipulating the search results sent to requesting Gnutella client device 22a so as to spoof the search results display with the false search results that are generated. This increases the chances that a user will select a false search result and further be inconvenienced by unwittingly downloading a false file.

While the above has been described with reference to the Gnutella peer-to-peer network 50, it will be understood that the principles described herein may be implemented in other networks, such as Gnutella2, eMule, FastTrack, BitTorrent, and/or NeoNet. It will be understood that the protocols for device connection, message-passing and the like may be different for different networks, but the principles of receiving a search request and performing an interfering action as described remain applicable. Furthermore, while the general operation of Gnutella client devices 22 have been described, it will be understood that the principles described herein may be implemented by a network sentry 12 with respect to client devices operating under the control of software such as Morpheus, Limewire, Bearshare, eMule, or Kazaa.

Many of the software packages that enable a device to connect to and operate on peer-to-peer networks support multi-source downloading (sometimes called “swarming”), which enables a requesting device to receive different portions of a single file from different network devices. With multi-source downloading, when requesting client device 22a receives search results, it identifies the same file on multiple devices 22b using an identifier such as its MD5 hash, matching filenames, or by some other means. When requesting device 22a then initiates a transfer of content, it requests different portions of the content from each responding device 22b. In a similar manner, when network sentry 12 responds to a request for protected content as described above, it identifies itself as having a copy of the protected content, and may be requested by requesting device 22a to provide a portion of a particular file. Network sentry 12 responds with garbage data, interfering with the entire transfer procedure from the multiple respondents.

An alternative to transferring garbage data in a false file is to distribute a false file with usable content (i.e. may be displayed or otherwise presented to the receiving user) other than that which is likely desired. For example, a video file warning a user that they are engaging in illegal activity could be provided instead of the protected content. Other variations may be conceived based on this principle. For example, the users could be redirected to a web site having information about possible consequences of receiving copyrighted content illegally. Another example is to provide a false audio file containing only a portion of a desired song accompanied by directions to visit a web site as an advertisement to legally purchase the complete song.

Transferring usable content is done in a manner similar to the transfer of garbage data. However, where the usable content to be transferred in a false file is related to the desired content (for example in the song portion example above), an additional relationship must be predefined between items in the list of protected content and the false file having usable content that is to be transferred in return. This may be done by the list having an extra element on each line denoting a file name of the false file having usable content. For example, a search for “Britney Spears” may result in transfer of a false file that plays only a first portion of a Britney Spears song with a warning, and a search for “Elton John” may result in transfer of a false file that plays only a first portion of an Elton John song with a warning. Where two or more artists are with the same record label, a single false file with a warning from the record label may be transferred rather than artist-specific content. As will be understood, the provision of usable content in false files generally requires pre-creation and storage of as many usable content false files as is required.

When transferring usable content false files, it may be useful to provide search results presenting access to multiple false files, each using different media, such as an audio file and a video file, or an MPEG file and an AVI file. This may be effective in the event that there is both protected video content and protected audio content of a single artist that would match a particular search criteria, since a user will only select in a search results display the search result of a desired media type (i.e., only desires audio, or only desires MPEG).

In order to continue being able to transfer usable content false files, random modifications to the usable content files may be made in a manner that does not render them unusable, but that enables generation of a new hash so that bad comments associated with an old hash are no longer related to the usable content false file. This may be done by ensuring that random modifications are only made to a changeable portion of a usable content file, such as a series of dummy data (e.g. a text string) within the program that is not actually used by the program. Furthermore, different usable content false files may be chosen partly based on location of requesting device 22a, date/time of the request etc.

Many of the software packages that enable a device to connect to and operate on peer-to-peer networks support the assignment of quality ratings and/or comments to content that helps users of the software determine the quality of a file before they download it. Network sentry 12 may be configured to assign high quality ratings and positive user comments to file(s) it offers in false search results in order to call attention to the search results it provides. This enables false search results produced by network sentry 12 to be listed more favorably in a search results display of requesting client device 22a. The comments may be randomly selected from a list of comments, randomly generated, and/or produced by some other means.

Network sentry 12 may encode information within the false file it transfers, and/or make modifications to the content. The nature of the encoded information and/or modification may be based on a search criteria, date/time, location of requesting client device 22a and/or some other criteria. For example, users could be referred to different warning/informational web sites depending on the location of requesting client device 22a. Location may be obtained by comparing the IP address of requesting client device 22a contained in a search request and/or file transfer request to a database that matches IP addresses to locations, by doing a reverse DNS lookup on the IP address, and/or by some other means. Alternatively, or in some combination, a filename and other information about the file is encoded into the file for the purpose of tracking or the like. Tracking is done, for example, by encoding a particular URL into a video file that supports opening of a URL upon execution. The particular URL includes encoded information such as a filename, the date and time of download, and/or other useful items. For example, the following URL includes a WWW address of a website and encoded information and may be embedded into a file prior to transfer by a network sentry 12:
http://peersentry.com/warn/warn.aspx?d=SFIUhdofisuhfDQWispdviphsdE POIHvfddosijSDOIS

The data in the URL after “?d=” is encoded in any acceptable manner so that the data is not readily apparent to a user. When the URL opens in the requesting user's web browser, a script on the web site identified by the WWW address (peersentry.com) decodes the data after “?d=” and displays a warning message informing the user that they are engaged in an illegal activity, along with information such as the user's IP address, their ISP name (obtained through a reverse DNS lookup), the name of the file they downloaded, etc. The information may also be recorded and used for other purposes, such as the initiation of legal proceedings against the user. The web page could also refer the user to places where the content could be legally purchased, such as a web store offering MP3 downloads.

A user may be deterred from downloading protected content when network sentry 12 returns search results that cause warning messages to appear in the actual search results display of requesting client device 22a. For example, users may be warned that their actions are illegal, and other information such as their IP address and/or the name of their Internet Service Provider (ISP) provided to show that their illegal activities are being monitored and that they may have to face consequences. As another example, users could be directed in this manner to web sites that sell legal, authorized copies of songs or movies or software or games or other content. In order to return such warning search results, a network sentry may return a large number of search results as has been described, except that each search result has a file name that is a warning message, resulting in a single-line warning message repeated many times.

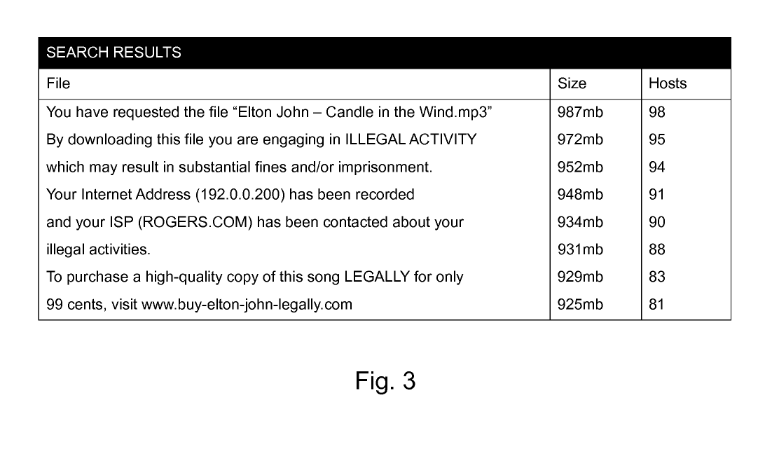

Another possible method of returning warning messages in the search results display is to create search results such that a multi-line text message is displayed in the search results display of requesting client device 22a. For example, each line of the message is identified as existing on a certain number of non-existent or otherwise dead-end devices, with higher message lines being identified as existing on more client devices and having progressively larger file sizes, and each line of text containing a unique hash or other file identifier. Because requesting client device 22a typically groups search results by hashes and sorts search results either by number of client devices hosting the file or by file size, this has the effect of spoofing the search results display of requesting client device 22a to cause a multi-line text message to appear, as shown in FIG. 3. Such multi-line text messages may be modified based on the location of requesting client device 22a, the contents of the search criteria, date/time, and/or other criteria.

As an alternative to sending deterring messages by spoofing the search results display, messages may be sent automatically to the users using the chat/messaging functionality of clients devices and/or by some other means.

The invention described herein may also be used to automatically identify client devices 22 that are offering content without authorization, and their users where permitted by the ISP.

Messages may be sent using e-mail or other means to users' Internet Service Providers (ISPs), or other interested parties, in order to provide notification that protected content is being transferred over the network 50 without authorization. In order to automatically send an e-mail to an ISP, network sentry 12 procures the e-mail address by parsing the IP address of client device(s) 22 in question and, as is well-known, performing a reverse DNS lookup which supplies the domain name. For example, such a reverse DNS lookup might provide the domain name “rogers.com”. Because most ISPs and other network providers have an “abuse” e-mail box set up where people can report spam and other abuse of their network 50, network sentry 12 may automatically create and send an e-mail to, for example, abuse@rogers.com. The e-mail may include information informing or reminding the ISP of the illegal nature of the activity, and warn of possible legal consequences to the ISP and/or the user if the activity continues. Network sentry 12 or central server 20 may keep a list of client devices 22 to or about which it has sent e-mails, so that if the illegal activity persists, content owners can be notified to take further action, legal or otherwise.

Any or all of the above actions, in some combination, may be performed for all searches received, rather than just those that relate to protected content. For example, a product or service may be advertised by distributing an MPEG movie file that contains an advertisement, or could be used, as another example, to send messages to all users whose searches are received.

Network sentry 12 may limit its operation to Internet Protocol (IP) addresses in a specific geographic region and/or modify its operations based on geographic criteria. The list of protected content would have a geographic element related to each <PHRASE>,<FEE> entry that would then be part of the criteria for determining whether the search request relates to the protected content. For example, this functionality could be used if a content owner wants to protect their content from being distributed by users in a specific country or a specific continent by limiting the interference to that country or continent, while enabling the content of other owners to be protected without geographic limitation.

While central server 20 has been described as being employed for maintaining information related to client devices 22 for access by network sentries 12 in order to connect as widely as possible across a network 50, it will be understood that central server 20 may perform many additional functions. These include maintaining and distributing lists of, and information about, client devices 22, such as IP addresses and ports, their type which peer-to-peer networks they connect to, lists of files shared by the client devices, etc. Central server 20 may also maintain a central list of protected content accessible by network sentries 12, or a master list of protected content for receiving updates, additions and for periodic distribution to network sentries 12. Central server 20 may also play a dual role as a network sentry. Central server 20 may also maintain a central log of the actions of network sentries 12 and fees incurred due to their actions.

Central server 20 may also keep track of and coordinate the actions of the multiple network sentries 12. For example, central server 20 may ensure that only a single network sentry 12 participates in a single act of interference, thereby preventing network bandwidth usable by network sentries 12 from being unnecessarily wasted.

Alternatively, network sentries 12 may intercommunicate in some manner without use of a central server.

An alternative implementation of the invention may be employed with peer-to-peer networks that operate such that client devices upload lists of their shared content to central servers. An example of such a network is eMule. According to this alternative implementation of the invention, network sentry 12 operates as previously described in this document, functioning however as a central server having the lists of shared content. Alternatively, in a network such as eMule, network sentry 12 functions in a manner similar to standard client devices 22 by uploading to the eMule central servers its list of shared content and a return path while making false files available for download as previously described. Network sentry 12 uploads its list of content (files) to multiple eMule central servers at once, thereby maximizing the number of client devices 16 to which its content is exposed and improving its chances of interference. In order to effectively provide interference, network sentry 12 connects to one or more eMule central servers and runs searches on the eMule central servers against its list of protected content. The search results received by the invention are then used as described to generate a list of file definitions which may be uploaded to the eMule central servers. For example, in the event that a record company wishes to interfere with unauthorized distribution of songs performed by Britney Spears, network sentry 12 connects to one or more eMule central servers and runs searches using the key words “Britney Spears”. The filenames, sizes, and other information returned by the eMule central servers are used to generate a list of false file definitions to upload to the central servers. Other users searching for these files would connect to network sentry 12 using the information that was uploaded to the eMule central servers to download their desired files, and instead obtain false files as described above, or reach a dead end.

While network sentry 12 has been described to be connected to a single network 50, it will be understood that network sentry 12 may also be connected to and in communications with devices on additional networks (for example, Gnutella and FastTrack). When operating across multiple networks, network sentry 12 uses a separate range of ports for each network, in order to keep communications with the different networks from conflicting with each other. Connected to multiple networks, network sentry 12 makes use of information it gathers from one network to facilitate its operations on the other networks. In this example, network sentry 12 monitors incoming QUERY HIT messages from multiple networks, and extracts filenames, file sizes, hashes, and other information from the QUERY HIT messages to use on any of the networks to which network sentry 12 is connected. It will be understood that the protocols for device connection, message-passing and the like may be different for different networks, but the principles of receiving a search request and performing an interfering action remain applicable.

Alternatively, it could be central server 20 that facilitates communications across networks and passes information from network sentries on one network to those on another.

In some implementations, network sentry 12 may return one or more valid search results (obtained from secondary devices as described) to a requesting client device 22a, along with a number of the false search results, as would be the case if network sentry 12 were a normal client device running, for example, Kazaa.

Although embodiments have been described, those of skill in the art will appreciate that variations and modifications may be made without departing from the purpose and scope of the invention defined by the appended claims.

What is claimed is:

1. A method of interfering with unauthorized distribution of protected content via a computer network, the method comprising:
receiving a query for content from a requesting device connected to the network;
determining whether the query relates to the protected content;
in the event that the query relates to the protected content, automatically taking an interfering action in respect of the requesting device.

2. The method of claim 1, wherein the interfering action comprises transmitting at least one false search result to the requesting device in response to the query.

3. The method of claim 2, further comprising:
prior to the transmitting, automatically creating the at least one false search result.

4. The method of claim 3, wherein the creating comprises:
relaying the query to at least one secondary device connected to the network;
obtaining from the at least one secondary device at least one secondary search result that corresponds to the relayed query;
composing the at least one false search result using components of the at least one secondary search result.

5. The method of claim 4, wherein the components relate to one or more files stored by the at least one secondary device and comprise at least one of: file size; file name; file rating; file hash.

6. The method of claim 2, further comprising:
receiving a request for download that is based on the at least one false search result from the requesting device; and
in response to the request for download, automatically transferring a false file to the requesting client.

7. The method of claim 6, wherein the false file comprises garbage data.

8. The method of claim 7, wherein a hash of the false file is periodically changed.

9. The method of claim 6, wherein contents of the false file are presentable to a user of the requesting device.

10. The method of claim 9, wherein the false file is one or more of: a text file; a video file; a sound file.

11. The method of claim 6, further comprising periodically changing attributes of the false file.

12. The method of claim 6, wherein the false file comprises a portion of the protected content combined with additional presentable content.

13. The method of claim 6, wherein the false file comprises tracking data.

14. The method of claim 13, wherein the tracking data comprises a URL.

15. The method of claim 6, further comprising logging transmission of the false file to the requesting device.

16. The method of claim 4, further comprising:
relaying the query to at least one secondary device connected to a secondary network;
obtaining from the at least one secondary device at least one secondary search result that corresponds to the relayed query;
composing the at least one false search result using components of the at least one secondary search result.

17. The method of claim 6, wherein the query contains a first download speed and the automatically transferring a false file is performed at a second download speed, the second download speed lower than the first download speed.

18. The method of claim 6, further comprising storing a record in a log file of the transferring of the false file.

19. The method of claim 18, wherein the record includes at least one of: a file name; a file size; a date/time; and a communications address of the requesting device.

20. The method of claim 19, wherein the record further includes a fee chargeable to an owner of the protected content for taking the interfering action.

21. The method of claim 20, wherein the fee is associated with a protection item in a list of the protected content used during the determining.

22. The method of claim 2, wherein the false search result comprises false download data.

23. The method of claim 22, wherein the false download data comprises at least one of: a false IP address; a false port number; a false filename; and a false hash.

24. The method of claim 2, wherein the at least one false search result comprises at least one electronic file definition.

25. The method of claim 24, wherein each of the at least one electronic file definition respectively comprises a unique file identifier, a file name, and a file size.

26. The method of claim 25, wherein the at least one electronic file definition further comprises a unique hash.

27. The method of claim 2, wherein at least one of the at least one false search result comprises a path to a false file.

28. The method of claim 2, wherein at least one of the at least one false search result is randomly generated.

29. The method of claim 2, wherein at least one of the at least one false search result comprises a message for display to a user of the requesting device.

30. The method of claim 2, wherein the at least one false search result comprises a deterring statement presentable to a user of the requesting device.

31. The method of claim 2, further comprising:
along with the at least one false search result, transmitting at least one valid search result to the requesting device.

32. The method of claim 2, wherein the false search result comprises a download speed.

33. The method of claim 27, wherein a filename of the false file is generated in response to the determining.

34. The method of claim 33, wherein a portion of the filename is randomly generated.

35. The method of claim 2, wherein the false search result comprises a false file path.

36. The method of claim 2, further comprising logging transmission of the false search result to the requesting device.

37. The method of claim 2, further comprising:
receiving a request for download that is based on the at least one false search result from the requesting device; and
in response to the request for download, automatically sending a false file to the requesting client; and
interrupting transfer of the false file prior to completion of the sending.

38. The method of claim 2, further comprising:
prior to the receiving, generating a set of false files and related hashes, wherein the false search results comprise at least one of the related hashes.

39. The method of claim 38, wherein the generating is periodically performed in order to refresh the set of false files and related hashed.

40. The method of claim 1, further comprising:
prior to the receiving a query, obtaining communications addresses of devices connected to the network;
conducting a handshake procedure with the devices using the communications addresses.

41. The method of claim 40, wherein the obtaining comprises accessing at least one server and retrieving the IP addresses and respective port numbers of the devices.

42. The method of claim 41, wherein the at least one server is a web cache accessible by all devices connected to the network.

43. The method of claim 41, wherein the at least one server is accessible on a secondary network.

44. The method of claim 40, wherein the obtaining comprises retrieving the communications addresses from storage.

45. The method of claim 40, wherein the obtaining comprises broadcasting a PING message and receiving PONG messages including the communications addresses.

46. The method of claim 1, wherein the query comprises a communications address of the requesting device and a search criteria.

47. The method of claim 46, wherein the determining comprises comparing the search criteria for matches with a protection item in a list of the protected content.

48. The method of claim 47, further comprising comparing the communications address of the requesting device to a geographic item.

49. The method of claim 48, wherein the geographic item is a geographic region, the method further comprising performing a reverse DNS (Domain Name System) lookup using the communications address of the requesting device to determine whether a geographic location of the requesting device is within the geographic region.

50. The method of claim 47, wherein both of the search criteria and the protection item is a text keyword or phrase.

51. The method of claim 47, further comprising:
prior to the determining, populating the list of the protected content using keywords or phrases relating to content to be protected.

52. The method of claim 1, wherein the network is a peer-to-peer network.

53. The method of claim 1, wherein the requesting device is running one of a Morpheus, Limewire, Bearshare, eMule and Kazaa client.

54. The method of claim 1, wherein the interfering action comprises transmitting a plurality of false search results relating to a single false file at multiple locations on the network to the requesting device in response to the query.

55. The method of claim 54, further comprising randomly generating a subset of the multiple locations.

56. The method of claim 1, wherein the interfering action comprises transmitting a message to a user of the requesting device.

57. An apparatus for interfering with unauthorized distribution of protected content via a computer network, the apparatus comprising:
a communications interface for receiving a query for content from a requesting device connected to the network;
a processor for determining whether the query relates to the protected content;
the processor further for, in the event that the query relates to the protected content, automatically taking an interfering action in respect of the requesting device.

58. The apparatus of claim 57, further comprising:
a storage device for storing a list of the protected content.

59. The apparatus of claim 57, wherein the interfering action comprises instructing a transmitter to transmit at least one false search result via the communications interface to the requesting device in response to the query.

60. The apparatus of claim 59, wherein the processor is further for prior to the instructing, automatically creating the at least one false search result by:
relaying the query via the communications interface to at least one secondary device connected to the network;
obtaining via the communications interface from the at least one secondary device at least one secondary search result that corresponds to the relayed query;
composing the at least one false search result using components of the at least one secondary search result.

61. The apparatus of claim 57, wherein the computer network is a peer-to-peer network.

62. The apparatus of claim 57, wherein the communications interface is further operable to receive messages from a central server via the computer network.

63. The apparatus of claim 57, wherein the communications interface is further operable to receive messages from devices on secondary computer networks.

65. The apparatus of claim 57, wherein the computer network is a Gnutella network.

66. A system for interfering with unauthorized distribution of protected content via a computer network, the system comprising:
a plurality of network sentries, each of the network sentries comprising:
a communications interface for receiving a query for content from a requesting device connected to the network;
a processor for determining whether the query relates to the protected content; and
the processor further for, in the event that the query relates to the protected content, automatically taking an interfering action in respect of the requesting device;
the system further comprising:
a central server in communication with the network sentries for sharing communications addresses of devices connected to the network.

67. The system of claim 66, wherein the central server further comprises:
a storage device for storing a list of the protected content.

68. The system of claim 66, wherein each of the network sentries comprises:
a storage device for storing a list of the protected content.

69. A computer readable medium including a computer program for interfering with unauthorized distribution of protected content via a computer network, the computer program comprising:
computer program code for receiving a query for content from a requesting device connected to the network;
computer program code for determining whether the query relates to the protected content; and
computer program code for in the event that the query relates to the protected content, automatically taking an interfering action in respect of the requesting device.
